(19) United States
(12) Patent Application Publication
(10) Pub. No.: US 2022/0414687 A1
(43) Pub. Date: Dec. 29, 2022

(54) METHOD, DEVICE, EQUIPMENT AND MEDIUM FOR DETERMINING CUSTOMER TABS BASED ON DEEP LEARNING

(71) Applicant: PING AN TECHNOLOGY (SHENZHEN) CO., LTD., Shenzhen, Guangdong (CN)

(72) Inventors: Cuiqin Hou, Shenzhen, Guangdong (CN); Jianfeng Li, Shenzhen, Guangdong (CN); Bin Wen, Shenzhen, Guangdong (CN)

(21) Appl. No.: 17/620,736

(22) PCT Filed: Sep. 24, 2020
(86) PCT No.: PCT/CN2020/117495

§ 371 Date: Dec. 19, 2021

(30) Foreign Application Priority Data
Aug. 6, 2020 (CN) 202010783681.9

(51) Int. Cl. G06Q 30/02

(52) U.S. Cl. CPC G06Q 30/0201

(57) ABSTRACT

Disclosed are a method, device, equipment and medium for determining customer tads based on deep learning. The method comprises the following steps: acquiring a conversation content between a customer and a robot customer service, inputting the conversation content into a preset multi-factor intent classifier to obtain a recognition result of product purchase intention output by the preset multi-factor intent classifier, setting a customer tab for the customer according to the recognition result of product purchase intention, and determining whether to provide manual service for the customer; acquiring a result of the manual service and conversation data of the customer in the manual service if the manual service is provided for the customer; and updating the customer tab of the customer according to the result of the manual service, and updating the preset multi-factor intent classifier according to the conversation data of the customer.

The present application claims the benefit of Chinese patent application filed with China Patent Office on Aug. 6, 2020, with the application number of 202010783681.9 and the title of “Method, device, equipment and medium for determining customer tabs based on deep learning”, the contents of which are incorporated herein by reference in their entirety.

### TECHNICAL FIELD

The application relates to the technical field of intelligent decision, in particular to a method, device, equipment and medium for determining customer tabs based on deep learning.

### BACKGROUND

With the development of artificial intelligence technology, especially the rapid development of natural speech processing technology, man-machine dialogue technology has attracted more and more attention and research from people from all walks of life, and man-machine dialogue products have sprung up constantly. In the field of customer service technology, the man-machine dialogue system can provide customers with consulting, sales and other related services 24 hours a year without interruption, which can greatly save manpower and cost. Therefore, the intelligent customer service robot serving customers is one of the most commercially valuable and most frequently used man-machine dialogue products.

### Technical Problems

However, the inventor found that due to the limitation of the existing artificial intelligence technology, although the existing intelligent customer service robots can provide services for customers at low cost and around the clock, they cannot provide high-quality and personalized services for customers. Especially in the pre-sales service that needs to promote products, it is necessary to screen customers according to the process of dialogue and communication with customers in order to improve the sales rate of products. However, in pre-sales service, intelligent customer service robots generally recognize customer's intention according to simple intention recognition methods, and respond mechanically according to the results of intention recognition, for example, by identifying keywords, a corresponding content edited in advance is triggered to appear. This kind of method is inaccurate in identifying customer's intention, which can only answer fewer questions, and the answer statements are blunt. As a result, the customer communication service is interrupted earlier, and the background can not accurately determine customers' purchase intentions based on a small amount of customer conversation data, which leads to low accuracy of customer screening and the inability to accurately screen out high value customers.

### Technical Solutions

The application provides a method, device, equipment and medium for determining customer tabs based on deep learning, aiming at solving the problem that the accuracy of customer screening is not high due to inaccurate identification of customer intentions in the prior art.

A method for determining customer tabs based on deep learning, including:

acquiring a conversation content between a customer and a customer service robot;

inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

setting a customer tab for the customer according to the recognition result of product purchase intention, and determining whether to provide manual service for the customer according to the customer tab of the customer;

acquiring a result of the manual service and conversation data of the customer in the manual service if the manual service is provided for the customer; and

updating the customer tab of the customer according to the result of the manual service, and updating the preset multi-factor intent classifier according to the conversation data of the customer.

A device for determining customer tabs based on deep learning, including:

a first acquisition module, configured to acquire a conversation content between a customer and a customer service robot;

an input module, configured to input the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

a setting module, configured to set a customer tab for the customer according to the recognition result of product purchase intention, and determining whether to provide manual service for the customer according to the customer tab of the customer;

a second acquisition module, configured to acquire a result of the manual service and conversation data of the customer in the manual service if the manual service is provided for the customer; and

an updating module, configured to update the customer tab of the customer according to the result of the manual service, and updating the preset multi-factor intent classifier according to the conversation data of the customer.

A computer equipment, including a memory, a processor, and computer readable instructions stored in the memory and executable on the processor, wherein the processor executes the computer readable instructions to implement following steps:

acquiring a conversation content between a customer and a customer service robot;

inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

setting a customer tab for the customer according to the recognition result of product purchase intention, and determining whether to provide manual service for the customer according to the customer tab of the customer;

acquiring a result of the manual service and conversation data of the customer in the manual service if the manual service is provided for the customer; and

updating the customer tab of the customer according to the result of the manual service, and updating the preset multi-factor intent classifier according to the conversation data of the customer.

A computer readable storage medium stores computer readable instructions which, when executed by a processor, implement the following steps:

acquiring a conversation content between a customer and a customer service robot;

inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

setting a customer tab for the customer according to the recognition result of product purchase intention, and determining whether to provide manual service for the customer according to the customer tab of the customer;

acquiring a result of the manual service and conversation data of the customer in the manual service if the manual service is provided for the customer; and

updating the customer tab of the customer according to the result of the manual service, and updating the preset multi-factor intent classifier according to the conversation data of the customer.

### Technical Effects

In the present application, the relevance between product purchase intention classification and conversation utterance inclination classification is considered in the training process of the preset multi-factor intent classifier, which improves the accuracy of the preset multi-factor intent classifier in identifying the customer's product purchase intention, and further sets the customer tab of the customer according to the recognition result with higher accuracy, so as to provide manual service according to the customer tabs, update the customer tabs according to the result of manual service, and improve the accuracy of determining customer tabs. In this way, customers can be accurately screened according to customer tabs, thus improving the quality of customer service. On this basis, the preset multi-factor intent classifier is constantly updated according to the conversation data of customers in the manual service process, which further improves the accuracy of the preset multi-factor intention classifier in identifying customer's intention and further improves the accuracy of customer screening.

Details of one or more embodiments of the present application are shown in the following drawings and description, and other features and advantages of the application will become apparent from the specification, drawings and claims.

### BRIEF DESCRIPTION OF DRAWINGS

In order to explain the technical solution of the embodiments of the present application more clearly, the drawings used in the description of the embodiments of the application will be briefly introduced below. Obviously, the drawings in the following description show only some embodiments of the application, and for those of ordinary skill in the field, other drawings may be obtained according to these drawings without any creative effort.

FIG. 1 is a diagram of an application environment of a method for determining customer tabs based on deep learning according to an embodiment of the present application;

FIG. 2 is a flow diagram of a method for determining customer tabs based on deep learning according to an embodiment of the present application;

FIG. 3 is a schematic diagram of an implementation process of Step S30 shown in FIG. 2;

FIG. 4 is a schematic diagram of another implementation process of Step S30 shown in FIG. 2;

FIG. 5 is a schematic diagram of an implementation process of Step S50 shown in FIG. 2;

FIG. 6 is an acquisition flow diagram of a preset multi-factor intent classifier according to an embodiment of the present application;

FIG. 7 is a schematic diagram of an implementation process of Step S06 shown in FIG. 6;

FIG. 8 is a structural diagram of a device for determining customer tabs based on deep learning according to an embodiment of the present application;

FIG. 9 is a structural diagram of a computer equipment according to an embodiment of the present application.

### DETAILED DESCRIPTION

The technical solution in the embodiments of the present application will be described clearly and completely with reference to the drawings in the embodiments of the application. Obviously, the described embodiments are part of the embodiments of the application, not all of them. Based on the embodiments in the present application, all other embodiments obtained by those skilled in the art without creative effort fall in the protection scope of the application.

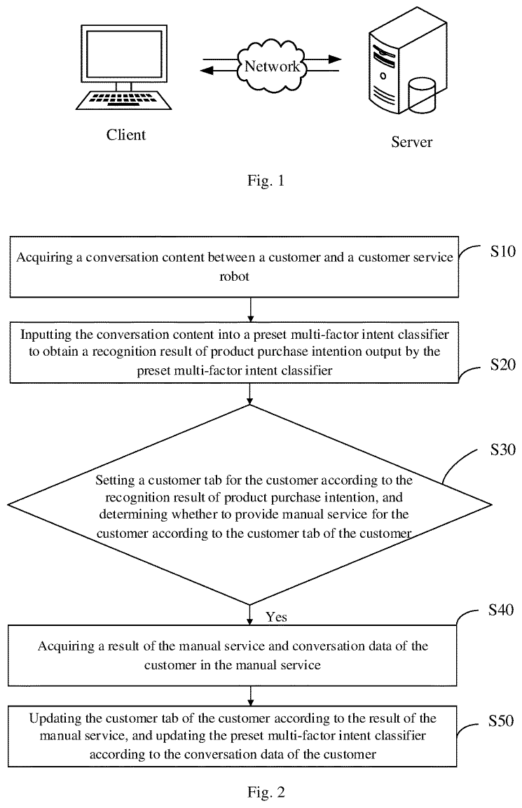

The method for determining the customer tabs based on deep learning provided by the embodiments of the present application may be applied in the application environment shown in FIG. 1, in which the client communicates with the server through network. The server obtains a conversation content between a customer and a customer service robot from the client, and inputs the conversation content into a preset multi-factor intent classifier to obtain a recognition result of product purchase intention output by the preset multi-factor intent classifier, and the preset multi-factor intent classifier is obtained by training product purchase intention classification and conversation utterance inclination classification according to customer conversation data of multiple customer tabs. The customer tabs include high-intent customers who have product purchase intention, low-intent customers who refuse the product and neutral customers who do not express their attitudes on the product. And then setting a customer tab for the customer according to the recognition result of product purchase intention, and determining whether to provide manual service for the customer according to the customer tab of the customer; acquiring a result of the manual service and conversation data of the customer in the manual service if the manual service is provided for the customer; and updating the customer tab of the customer according to the result of the manual service, and updating the preset multi-factor intent classifier according to the conversation data of the customer.

Wherein, the client may be but not limited to various personal computers, notebook computers, smart phones, tablet computers and portable wearable devices. The server may be an independent server or a server cluster composed of multiple servers.

In an embodiment, as shown in FIG. 2, a method for determining the customer tabs based on deep learning is provided, which is illustrated by taking the application of the method to the server shown in FIG. 1 as an example, and includes the following steps:

S10: acquiring a conversation content between a customer and a customer service robot.

When the customer communicates with the customer service robot through a client, the conversation content between the customer and the customer service robot is obtained, so as to identify the customer's purchase intention of the product according to the conversation content input by the customer.

S20: inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product.

After acquiring the conversation content between the customer and customer service robot, the acquired conversation content is input into the preset multi-factor intent classifier stored in the blockchain database to obtain a recognition result of product purchase intention of the customer output by the preset multi-factor intent classifier, so as to determine whether the customer has purchase intention.

Wherein, the preset multi-factor intent classifier is obtained by training product purchase intention classification and conversation utterance inclination classification according to customer conversation data of multiple customer tabs. The multiple customer tabs include high-intent customers who have product purchase intention, low-intent customers who refuse the product and neutral customers who do not express their attitudes on the product. The above further improves the diversity of training data of the preset multi-factor intent classifier and increases the accuracy of the preset multi-factor intent classifier. Different from the conventional intent classifier, the preset multi-factor intent classifier considers the correlation between the customer's purchase intention and the customer's inclination in different dialogue stages, and thus has higher accuracy in identifying the customer's purchase intention. In this embodiment, the customer's purchase intention in the dialogue process is identified by the preset multi-factor intent classifier, so that the automatic processing of artificial intelligence+intention recognition is realized, and the intention recognition result can be obtained quickly and accurately without human intervention, thus improving the recognition efficiency and accuracy.

In addition, during the training of product purchase intention classification and conversation utterance inclination classification according to customer conversation data of various customer tabs, the acquired relevant data and the generated preset multi-factor intent classifier may be stored in the blockchain network.

Blockchain is a new application mode of computer technology such as distributed data storage, point-to-point transmission, consensus mechanism and encryption algorithm. Blockchain, in essence, is a decentralized database, which is a series of data blocks generated by cryptography. Each data block contains a batch of information of network transactions, which is used to verify the validity (anti-counterfeiting) of the information and generate the next block. Blockchain may include blockchain underlying platform, platform product service layer and application service layer. In this embodiment, the preset multi-factor intent classifier and related data are stored in the blockchain network, which is convenient for quick query of the target classifier and data, and improves the processing speed.

S30: setting a customer tab for the customer according to the recognition result of product purchase intention, and determining whether to provide manual service for the customer according to the customer tab of the customer.

After obtaining the recognition result of product purchase intention output by the preset multi-factor intent classifier, a customer tab of the customer is set according to the recognition result of product purchase intention, and whether to provide manual service for the customer is determined according to the set customer tab.

For example, if the customer is a neutral customer according to the customer tab, it is determined not to provide manual service for the customer, and the customer service robot would be controlled to continue the dialogue with the customer until the dialogue is over.

S40: acquiring a result of the manual service and conversation data of the customer in the manual service if the manual service is provided for the customer.

If it is determined to provide manual service for the customer according to the customer tab, the customer will be transferred to manual service, so that experienced customer service personnel can provide personalized manual service for the customer. In the process of providing manual service for the customer, the customer's conversation data and result of manual service are recorded, so that the result of the manual service and the conversation data can be inquired and extracted later.

The manual service may be a product promotion service, and in other embodiments, the manual service may also be other types of services. In this embodiment, the manual service is explained by taking the product promotion service as an example.

S50: updating the customer tab of the customer according to the result of the manual service, and updating the preset multi-factor intent classifier according to the conversation data of the customer.

After acquiring the results of manual service and the conversation data of customers, update the customer tabs of customers according to the results of manual service, so as to improve the accuracy of customer tabs, thus laying a foundation for providing different service strategies for customers with different customer tabs. In addition, the preset multi-factor intent classifier will be updated according to the conversation data of customers, that is, the preset multi-factor intent classifier will be retrained according to the conversation data obtained from the manual service process, so as to improve the accuracy of the preset multi-factor intent classifier in identifying customers' purchase intentions, so that with the continuous working of the server, the accuracy of the results predicted by the preset multi-factor intent classifier will become higher and higher.

In this embodiment, the conversation content between a customer and customer service robot is obtained and input into a preset multi-factor intent classifier to obtain a recognition result of product purchase intention output by the preset multi-factor intent classifier. Then, according to the recognition result of product purchase intention, the customer tab is set for the customer, and whether to provide manual service for the customer us determined according to the customer tab. If manual service is provided for the customer, the results of manual service and customer conversation data of the manual service are obtained. In the training process of the preset multi-factor intent classifier, the correlation between product purchase intention classification and conversation utterance inclination classification is considered, which improves the accuracy of the preset multi-factor intent classifier in identifying the customer's product purchase intention, and further sets the customer tab of the customer according to the recognition result. In this way, customers can be accurately screened according to customer tabs, thus improving the quality of customer service. On this basis, the preset multi-factor intent classifier is constantly updated according to the conversation data of customers in the manual service process, which further improves the accuracy of the preset multi-factor intention classifier in identifying customer's intention and further improves the accuracy of customer screening.

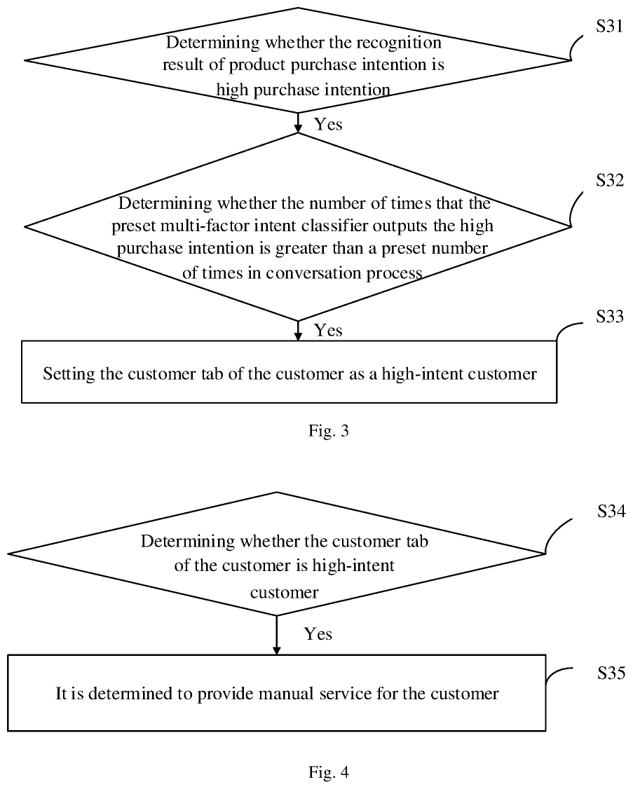

In an embodiment, after obtaining the recognition result of product purchase intention output by the preset multi-factor intent classifier, the Step S30 of setting a customer tab for the customer according to the recognition result of product purchase intention includes the following steps, as shown in FIG. 3.

S31: determining whether the recognition result of product purchase intention is high purchase intention.

After obtaining recognition result of product purchase intention output by the preset multi-factor intent classifier, it is determined whether the recognition result of product purchase intention is high purchase intention, so as to set the customer tab according to the recognition result.

S32: if the recognition result of product purchase intention is determined to be high purchase intention, determining whether the number of times that the preset multi-factor intent classifier outputs the high purchase intention is greater than a preset number of times in conversation process.

After determining whether the recognition result of product purchase intention is high purchase intention or not, if it is determined that the recognition result of product purchase intention is high purchase intention, count the number of times that the preset multi-factor intent classifier outputs high purchase intention in the conversation process, and determine whether the number of times that the preset multi-factor intent classifier outputs high purchase intention is greater than the preset number.

If, in the conversation, the number of times that the preset multi-factor intent classifier outputs high purchase intention is greater than 0 and not greater than the preset number, the customer tab of the customer is set as a low-intent customer.

S33: if the preset multi-factor intent classifier outputs the high purchase intention more than the preset number of times, setting the customer tab of the customer as a high-intent customer.

After determining whether the number of times the preset multi-factor intent classifier outputs high purchase intention is greater than the preset number, if, in the conversation, the number of times the preset multi-factor intention classifier outputs high purchase intention is greater than the preset number, the customer tab of the customer is set as a high-intent customer. In this way, the high-intent customer could receive personalized manual service according to the customer tab, thereby the service experience of the customer is improved.

In this embodiment, after obtaining the recognition result of product purchase intention output by the preset multi-factor intent classifier, it is determined whether the recognition result of product purchase intention is high purchase intention. Then, in the conversation process, it is determined whether the number of times the preset multi-factor intent classifier outputs high purchase intention is greater than the preset number. If the number of times the preset multi-factor intent classifier outputs high purchase intention is greater than the preset number, the customer tab of the customer is set as high-intent customer, which refines the steps of setting the customer tab according to the recognition result of product purchase intention, clarifies the process of determining high-intent customer according to the number of times the preset multi-factor intent classifier outputs high purchase intention, and laying a foundation for providing different service strategies for customers with different customer tabs.

In an embodiment, if it is determined that the recognition result of product purchase intention is low purchase intention, and the number of times that the preset multi-factor intent classifier outputs low purchase intention is greater than a first preset threshold, the customer tab of the customer is set as low-intent customer. If it is determined that the recognition result of product purchase intention is neutral intention without expressing attitudes of the product, and the number of times that the preset multi-factor intent classifier outputs the neutral intention is greater than a second preset threshold, the customer tab of the customer is set as a neutral customer. In this way, the customer group can be screened according to the customer tabs, and then different customer services may be provided.

In an embodiment, as shown in FIG. 4, in Step S30, it is determined whether to provide manual service for the customer according to the customer tab of the customer, which specifically includes the following steps:

S34: determining whether the customer tab of the customer is high-intent customer.

After setting the customer's customer tab according to the recognition result of product purchase intention, determine whether the customer's customer tab is high-intent customer.

S35: if the customer tab of the customer is a high-intent customer, it is determined to provide manual service for the customer.

After determining whether the customer's customer tab is high-intent customer, and if yes, it is determined to provide manual service for the customer and transfer the customer to manual customer service to improve the customer's service experience.

After determining whether the customer's customer tab is a high-intent customer, if not (i.e., the customer tab is a low-intent customer or neutral customer), it is determined not to provide manual service for the customer, and the customer service robot will continue the communication with the customer until the dialogue ends.

In this embodiment, after setting the customer tab according to recognition result of the product purchase intention, it is determined whether to provide manual service according to the determination result. If it is determined that the customer tab is a high-intent customer, it is determined to provide manual service for the customer, which further refines the steps of determining whether to provide manual service for the customer according to the customer tab, optimizes the customer service strategies of different customer tabs, and improves the customer service experience for high-intent customers.

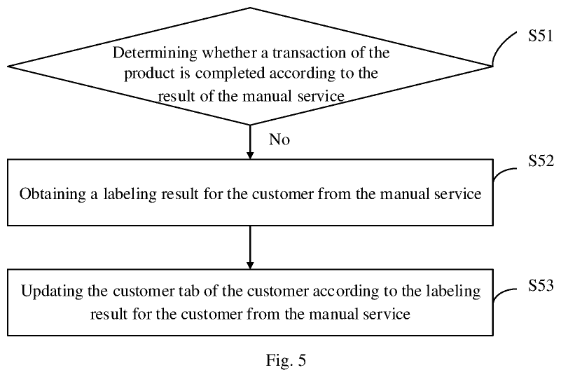

In an embodiment, after obtaining the result of the manual service, as shown in FIG. 5, in Step S50, the customer tab is updated according to the result of the manual service, which specifically includes the following steps:

S51: determining whether a transaction of the product is completed according to the result of the manual service.

After providing customers with manual service of product promotion and obtaining the result of the manual service, it is determined whether the product transaction is completed according to the result of the manual service, so as to determine whether the customer tab needs to be updated according to the transaction statuses.

S52: if the transaction of the product is not completed, obtaining a labeling result for the customer from the manual service.

In the process of providing product recommendation service to customers with high intention, if the product transaction is not completed, service staff can re-mark the customer's product purchase intention. Therefore, after determining whether the product transaction is completed according to the result of manual service, if it is determined that the product transaction is not completed, the labeling result of the manual customer service on the customer's product purchase intention may be obtained, so as to update the customer tab according to the labeling result.

S53: updating the customer tab of the customer according to the labeling result for the customer from the manual service.

After confirming that the product transaction is not completed and obtaining the labeling result of manual service, update the customer tab according to the labeling result of manual service.

For example, if it is determined that the transaction of the product has not been completed and the result of manual service is low-intent customer, the customer tab of the customer would be updated from high-intent customer to low-intent customer.

In this embodiment, after providing customer with manual service for product promotion and obtaining the result of the manual service, it is determined whether the product transaction is achieved according to the result of the manual service. And if the product transaction is not achieved, the labeling result of the manual service is obtained, and then the customer tab of the customer is updated according to the labeling result of the manual service, thus refining the steps of updating the customer tab of the customer according to the result of the manual service. After pushing a number of services to high-intent customers, the customer tabs are updated according to the transaction statuses and the labeling results of manual service, which further improves the accuracy of the customer tabs and facilitates the subsequent screening of high-quality customers according to the customer tabs.

In an embodiment, after determining whether the product transaction is completed according to the result of manual service, If the transaction of the product is completed, keep the customer tab as high-intention customer, and label the customer with transaction-completed, so as to further refine the customer tabs and facilitate the subsequent screening of customers according to the customer tabs and labeling results.

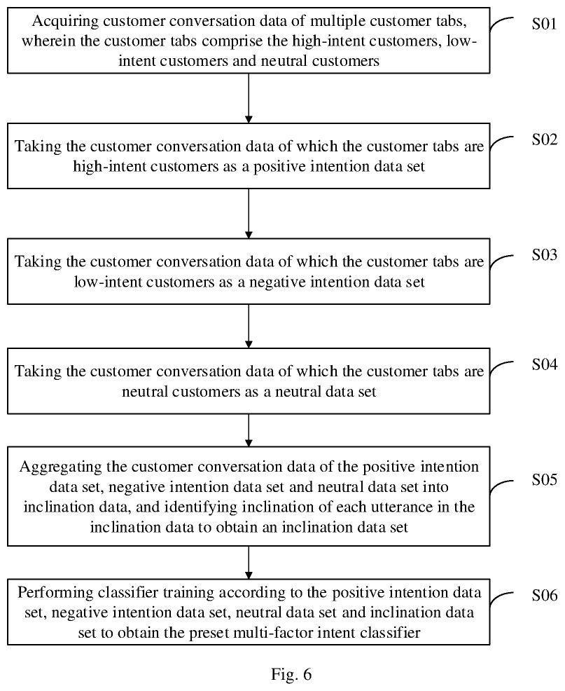

In an embodiment, before inputting the conversation content into the preset multi-factor intent classifier, it further needs to carry out the training of product purchase intention classification and conversation utterance inclination classification according to customer conversation data of multiple customer tabs to obtain the preset multi-factor intent classifier. As shown in FIG. 6, the preset multi-factor intent classifier is obtained as follows:

S01: acquiring customer conversation data of multiple customer tabs, wherein the customer tabs include the high-intent customers, low-intent customers and neutral customers.

Acquiring historically stored customer conversation data with different customer tabs, wherein the customer tabs include high-intent customers who have purchase intention for product, low-intent customers who refuse the product and neutral customers who have not expressed their attitudes on the products, that is, the customer conversation data includes conversation data of high-intent customers, conversation data of low-intent customers and conversation data of neutral customers.

In an embodiment, before obtaining the customer conversation data with the customer tab, it is necessary to determine the overall purchase intention of the customer according to the historical conversation data of each customer, and then set a customer tab for the customer according to the overall purchase intention of the customer, so as to obtain enough customer conversation data of various customer tabs for training the preset multi-factor intent classifier.

For example, it can be determined whether the customer conversation data is related to the product by querying the customer conversation data in historical storage: if it is found that the customer is interested in the product through the intention of customer conversation statements (such as how to check the policy, consult the policy guaranty content, and how to purchase, etc.), and the customer has made a positive inquiry or learned about the product, then it is determined that the customer purchase intention for the product is positive, that is, the user has the intention to purchase the product, and then the customer tab is set as a high-intent customer. If the customer's question is related to the product, but it is determined that the customer's attitude is questioning or even complaining through the intention of customer conversation statements (such as no time, have no use for, etc.), then it is determined that the customer purchase intention for the product is negative, that is, the user refuses to learn about or purchase the product, then the customer tab is set as a low-intent customer, and the customer conversation data is determined to be negative intention data. If the customer conversation data show that the customer's intention is not relevant to the product (such as greeting, closing words, etc.), it would be determined that the customer has not expressed his attitude on the product and cannot determine the customer purchase intention, then the customer tab would be set as a neutral customer, and the customer conversation data is determined to be neutral data.

S02: taking the customer conversation data of which the customer tabs are high-intent customers as a positive intention data set.

After obtaining the customer conversation data of different customer tabs, the customer conversation data of customers labeled as high-intent customers are taken as the positive intention data set, i.e., the conversation data of customers who are interested in the product and have intention to purchase the product are taken as the positive intention data set.

S03: taking the customer conversation data of which the customer tabs are low-intent customers as a negative intention data set.

After obtaining the customer conversation data of different customer tabs, the customer conversation data of customers labeled as low-intent customers are taken as the negative intention data set, i.e., the conversation data of customers who refuse to learn about or purchase products are taken as the negative intention data set.

S04: taking the customer conversation data of which the customer tabs are neutral customers as a neutral data set.

After obtaining the customer conversation data of different customer tabs, the customer conversation data of customers labeled as neutral customers are taken as the neutral data set, i.e., the conversation data of customers who does not express their attitudes on the product are taken as neutral data set.

S05: aggregating the customer conversation data of the positive intention data set, negative intention data set and neutral data set into inclination data, and identifying inclination of each utterance in the inclination data to obtain an inclination data set.

After obtaining the positive intention data set, negative intention data set and neutral data set, the customer conversation data of the positive intention data set, negative intention data set and neutral data set are aggregated into an inclination data, and the inclination of each utterance in the inclination data is identified to obtain an inclination data set, which includes inclination data and the inclination corresponding to each conversation utterance in the inclination data.

S06: performing classifier training according to the positive intention data set, negative intention data set, neutral data set and inclination data set to obtain the preset multi-factor intent classifier.

After obtaining the positive intention data set, negative intention data set, neutral data set and inclination data set, the classifier training of product purchase intention classification and conversation utterance inclination classification is carried out according to the positive intention data set, negative intention data set, neutral data set and inclination data set to obtain the preset multi-factor intent classifier. In the process of training the preset multi-factor intent classifier, not only the combination learning effect of the two tasks (i.e., product purchase intention classification and conversation utterance inclination classification), but also the correlation between the intention classification task and the inclination classification task are considered. The preset multi-factor intent classifier obtained by this method has higher accuracy in identifying the customer's intention and can more accurately predict the customer's intention to purchase products.

In this embodiment, by obtaining customer conversation data of different customer tabs (including high-intent customers, low-intent customers and neutral customers), the customer conversation data labeled as high-intent customers are taken as a positive intention data set, the customer conversation data labeled as low-intent customers are taken as a negative intention data set, and the customer conversation data labeled as neutral customers are taken as a neutral data set. The conversation data of positive intention data set, negative intention data set and neutral data set are aggregated into an inclination data, and the inclination of each utterance in the inclination data set is identified to obtain an inclination data set. The classifier training is carried out according to the positive intention data set, negative intention data set, neutral data set and inclination data set to obtain the preset multi-factor intent classifier. The source and type of training data are clarified, and the process of obtaining the preset multi-factor intent classifier is clarified. It provides a basis for identifying the customer's product purchase intention according to the preset multi-factor intent classifier in the subsequent dialogue process, thus improving the accuracy of identifying the customer's product purchase intention.

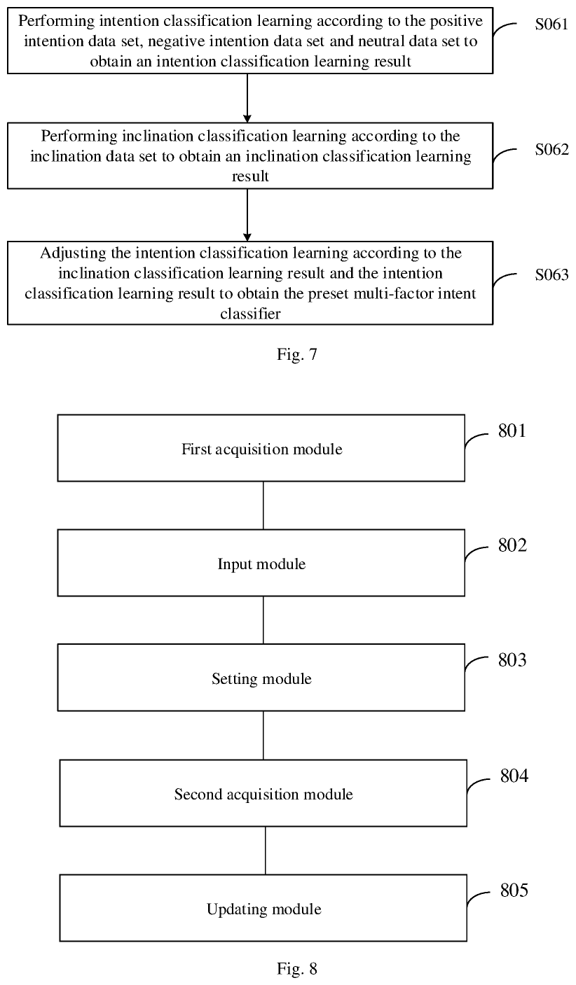

In an embodiment, as shown in FIG. 7, the Step S06 of performing classifier training according to the positive intention data set, negative intention data set, neutral data set and inclination data set to obtain the preset multi-factor intent classifier, includes the following steps:

S061: performing intention classification learning according to the positive intention data set, negative intention data set and neutral data set to obtain an intention classification learning result.

After acquiring the positive intention data set, negative intention data set and neutral data set, performing intention classification learning according to the positive intention data set, negative intention data set and neutral data set to obtain an intention classification learning result. Wherein, the intention classification learning result is the recognition result of product purchase intention of a customer.

S062: performing inclination classification learning according to the inclination data set to obtain an inclination classification learning result.

After obtaining the inclination data set, the inclination classification learning is performed according to the inclination data set to obtain the inclination classification learning result, wherein the inclination classification learning result is the intention recognition result of conversation utterance in a phased dialogue or a single dialogue statement.

S063: adjusting the intention classification learning according to the inclination classification learning result and the intention classification learning result to obtain the preset multi-factor intent classifier.

After obtaining the inclination classification learning results and the intention classification learning result, adjusting the intention classification learning according to the inclination classification learning result and the intention classification learning result to obtain the preset multi-factor intent classifier. That is, in the training process of the preset multi-factor intent classifier, not only the combination learning effect of inclination classification learning and intention classification learning, but also the correlation between inclination classification learning and intention classification learning are considered. And the correlation between the inclination classification learning and the intention classification learning is specifically to consider the consistency between the prediction result of the inclination classification learning and the prediction result of the intention classification learning, and further consider the consistency between the prediction result of the inclination classification learning and the real result of purchase intention product, so as to improve the accuracy of the trained preset multi-factor intent classifier.

In this embodiment, the intention classification learning is performed according to positive intention data set, negative intention data set and neutral data set to obtain an intention classification learning result. And the inclination classification learning is performed according to the inclination data set to obtain an inclination classification learning result. The intention classification learning is adjusted according to the inclination classification learning result and intention classification learning result to obtain a preset multi-factor intent classifier, so the process of performing classifier training according to the positive intention data set, negative intention data set, neutral data set and inclination data set to obtain the preset multi-factor intent classifier is further refined. The influence of the inclination of the customer conversation utterance data on the product purchase intention recognition of the customer is fully considered, the intention classification learning is adjusted according to the inclination classification learning result and intention classification learning result, and the correlation between the inclination classification and the intention classification is considered, so that the accuracy of the preset multi-factor intent classifier is improved, and a basis is provided for accurately identifying the product purchase intention of the customer in the subsequent dialogue process with the customer.

It should be understood that the numbers of the steps in the above embodiments do not indicate the order of implementation. The order of implementation of each step should be determined by its function and internal logic, and shall not constitute any limitation on the implementation process of the embodiments of the present application.

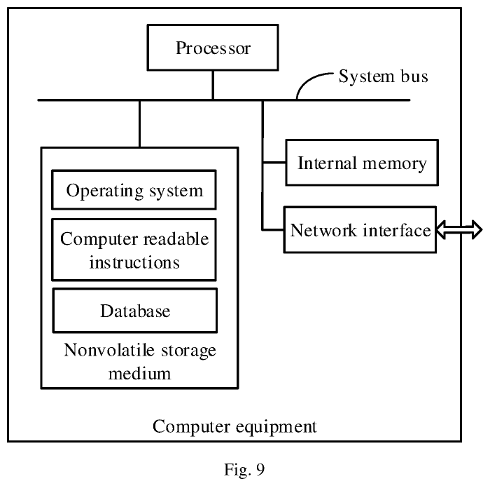

In an embodiment, a device for determining customer tabs based on deep learning is provided, which corresponds to the method for determining customer tabs based on deep learning described in the above embodiments one by one. As shown in FIG. 8, the device for determining customer tabs based on deep learning includes a first acquisition module 801, an input module 802, a setting module 803, a second acquisition module 804 and an updating module 805. Detailed description of each functional module is as follows:

a first acquisition module 801, configured to acquire a conversation content between a customer and a customer service robot;

an input module 802, configured to input the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

a setting module 803, configured to set a customer tab for the customer according to the recognition result of product purchase intention, and determining whether to provide manual service for the customer according to the customer tab of the customer;

a second acquisition module 804, configured to acquire a result of the manual service and conversation data of the customer in the manual service if the manual service is provided for the customer; and an updating module 805, configured to update the customer tab of the customer according to the result of the manual service, and updating the preset multi-factor intent classifier according to the conversation data of the customer.

Further, the setting module 803 is specifically used for:

determining whether the recognition result of product purchase intention is high purchase intention;

if the recognition result of product purchase intention is determined to be high purchase intention, determining whether the number of times that the preset multi-factor intent classifier outputs the high purchase intention is greater than a preset number of times in conversation process;

and if the preset multi-factor intent classifier outputs the high purchase intention more than the preset number of times, setting the customer tab of the customer as a high-intent customer.

Further, the setting module 803 is specifically used for:

if the customer tab of the customer is a high-intent customer, it is determined to provide manual service for the customer.

Further, the updating module 805 is specifically used for:

determining whether a transaction of the product is completed according to the result of the manual service;

if the transaction of the product is not completed, obtaining a labeling result for the customer from the manual service; and

updating the customer tab of the customer according to the labeling result for the customer from the manual service.

Further, the device for determining customer tabs based on deep learning further includes a third acquisition module 806, which is specifically used for:

acquiring customer conversation data of multiple customer tabs, wherein the customer tabs include the high-intent customers, low-intent customers and neutral customers;

taking the customer conversation data of which the customer tabs are high-intent customers as a positive intention data set;

taking the customer conversation data of which the customer tabs are low-intent customers as a negative intention data set;

taking the customer conversation data of which the customer tabs are neutral customers as a neutral data set;

aggregating the customer conversation data of the positive intention data set, negative intention data set and neutral data set into inclination data, and identifying inclination of each utterance in the inclination data to obtain an inclination data set; and performing classifier training according to the positive intention data set, negative intention data set, neutral data set and inclination data set to obtain the preset multi-factor intent classifier.

Further, the third acquisition module 806 is specifically used for:

performing intention classification learning according to the positive intention data set, negative intention data set and neutral data set to obtain an intention classification learning result;

performing inclination classification learning according to the inclination data set to obtain an inclination classification learning result; and

adjusting the intention classification learning according to the inclination classification learning result and the intention classification learning result to obtain the preset multi-factor intent classifier.

For the specific definition of the device for determining customer tabs based on deep learning, please refer to the above definition of the method for determining customer tabs based on deep learning, which will not be described in detail in the followings. Each module of the device for determining customer tabs based on deep learning may be implemented in whole or in part by software, hardware and their combinations. The above modules may be embedded in the form of hardware or independent of the processor in the computer equipment, or may be stored in the memory of the computer equipment in the form of software, so that the processor can call and execute the operations corresponding to the above modules.

In an embodiment, a computer equipment is provided, which may be a server, and its internal structure diagram is shown in FIG. 9. The computer equipment includes a processor, a memory, a network interface and a database which are connected through a system bus. Wherein the processor of the computer equipment is used for providing computing and control capabilities. The memory of the computer equipment includes a nonvolatile storage medium and/or a volatile storage medium and an internal memory. The nonvolatile storage medium stores an operating system, computer readable instructions and a database. The internal memory provides an environment for the operation of the operating system and computer readable instructions in the nonvolatile storage medium. The database of the computer equipment is used for the data applied and generated in the preset multi-factor intent classifier and the method for determining customer tabs based on deep learning. The network interface of the computer equipment is used to communicate with external terminals through network connection. The computer readable instructions, when executed by the processor, realize the method for determining customer tabs based on deep learning.

In one embodiment, a computer equipment is provided, including a memory, a processor, and computer readable instructions stored in the memory and executable on the processor, wherein the processor executes the computer readable instructions to implement following steps:

acquiring a conversation content between a customer and a customer service robot;

inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

setting a customer tab for the customer according to the recognition result of product purchase intention, and determining whether to provide manual service for the customer according to the customer tab of the customer;

acquiring a result of the manual service and conversation data of the customer in the manual service if the manual service is provided for the customer; and

updating the customer tab of the customer according to the result of the manual service, and updating the preset multi-factor intent classifier according to the conversation data of the customer.

In one embodiment, a computer readable storage medium is provided and stores computer readable instructions which, when executed by a processor, implement the following steps:

acquiring a conversation content between a customer and a customer service robot;

inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;

setting a customer tab for the customer according to the recognition result of product purchase intention, and determining whether to provide manual service for the customer according to the customer tab of the customer;

acquiring a result of the manual service and conversation data of the customer in the manual service if the manual service is provided for the customer; and

updating the customer tab of the customer according to the result of the manual service, and updating the preset multi-factor intent classifier according to the conversation data of the customer.

A person of ordinary skill in the art can understand that all or part of the processes in the method of the foregoing embodiments can be implemented by instructing related hardware through computer readable instructions, which can be stored in a nonvolatile computer readable storage medium, and the computer readable instructions can include the steps of the above embodiments. Wherein, any reference to memory, storage, database or other medium used in the embodiments provided in this application may include nonvolatile and/or volatile memory. The nonvolatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus, (Rambus) direct RAM (RDRAM), direct memory bus dynamic RAM (DRDRAM), and memory bus dynamic RAM (RDRAM), etc.

A person of ordinary skill in the art can clearly understand that, for the convenience and conciseness of description, the division of the above functional units and modules are only used as examples. In practical applications, the above functions may be implemented by different functional units and modules as needed. That is, the internal structure of the device may be divided into different functional units or modules to complete all or part of the functions described above.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and should be included in the protection scope of this application.

1. A method for determining customer tabs based on deep learning, comprising:
acquiring a conversation content between a customer and a customer service robot;
inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;
setting a customer tab for the customer according to the recognition result of product purchase intention, and determining whether to provide manual service for the customer according to the customer tab of the customer;
acquiring a result of the manual service and conversation data of the customer in the manual service if the manual service is provided for the customer; and
updating the customer tab of the customer according to the result of the manual service, and updating the preset multi-factor intent classifier according to the conversation data of the customer.

2. The method for determining customer tabs based on deep learning of claim 1, wherein the step of setting a customer tab for the customer according to the recognition result of product purchase intention comprises:
determining whether the recognition result of product purchase intention is high purchase intention;
if the recognition result of product purchase intention is determined to be high purchase intention, determining whether the number of times that the preset multi-factor intent classifier outputs the high purchase intention is greater than a preset number of times in conversation process; and
if the preset multi-factor intent classifier outputs the high purchase intention more than the preset number of times, setting the customer tab of the customer as a high-intent customer.

3. The method for determining customer tabs based on deep learning of claim 1, wherein the step of determining whether to provide manual service for the customer according to the customer tab of the customer comprises:
if the customer tab of the customer is a high-intent customer, it is determined to provide manual service for the customer.

4. The method for determining customer tabs based on deep learning of claim 1, wherein the step of updating the customer tab of the customer according to the result of the manual service comprises:
determining whether a transaction of the product is completed according to the result of the manual service;
if the transaction of the product is not completed, obtaining a labeling result for the customer from the manual service; and
updating the customer tab of the customer according to the labeling result for the customer from the manual service.

5. The method for determining customer tabs based on deep learning of claim 1, wherein the preset multi-factor intent classifier is obtained by following way:
acquiring customer conversation data of multiple customer tabs, wherein the customer tabs comprise the high-intent customers, low-intent customers and neutral customers;
taking the customer conversation data of which the customer tabs are high-intent customers as a positive intention data set;
taking the customer conversation data of which the customer tabs are low-intent customers as a negative intention data set;
taking the customer conversation data of which the customer tabs are neutral customers as a neutral data set;
aggregating the customer conversation data of the positive intention data set, negative intention data set and neutral data set into inclination data, and identifying inclination of each utterance in the inclination data to obtain an inclination data set; and
performing classifier training according to the positive intention data set, negative intention data set, neutral data set and inclination data set to obtain the preset multi-factor intent classifier.

6. The method for determining customer tabs based on deep learning of claim 5, wherein the step of performing classifier training according to the positive intention data set, negative intention data set, neutral data set and inclination data set to obtain the preset multi-factor intent classifier comprises:
performing intention classification learning according to the positive intention data set, negative intention data set and neutral data set to obtain an intention classification learning result;
performing inclination classification learning according to the inclination data set to obtain an inclination classification learning result; and
adjusting the intention classification learning according to the inclination classification learning result and the intention classification learning result to obtain the preset multi-factor intent classifier.

7. (canceled)

8. The device for determining customer tabs based on deep learning of claim 7, wherein the setting module is specifically configured to:
determine whether the recognition result of product purchase intention is high purchase intention;
if the recognition result of product purchase intention is determined to be high purchase intention, determine whether the number of times that the preset multi-factor intent classifier outputs the high purchase intention is greater than a preset number of times in conversation process; and
if the preset multi-factor intent classifier outputs the high purchase intention more than the preset number of times, set the customer tab of the customer as a high-intent customer.

9. A computer equipment, comprising a memory, a processor, and computer readable instructions stored in the memory and executable on the processor, wherein the processor executes the computer readable instructions to implement following steps:
acquiring a conversation content between a customer and a customer service robot;
inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;
setting a customer tab for the customer according to the recognition result of product purchase intention, and determining whether to provide manual service for the customer according to the customer tab of the customer;
acquiring a result of the manual service and conversation data of the customer in the manual service if the manual service is provided for the customer; and
updating the customer tab of the customer according to the result of the manual service, and updating the preset multi-factor intent classifier according to the conversation data of the customer.

10. The computer equipment of claim 9, wherein the step of setting a customer tab for the customer according to the recognition result of product purchase intention comprises:
determining whether the recognition result of product purchase intention is high purchase intention;
if the recognition result of product purchase intention is determined to be high purchase intention, determining whether the number of times that the preset multi-factor intent classifier outputs the high purchase intention is greater than a preset number of times in conversation process; and
if the preset multi-factor intent classifier outputs the high purchase intention more than the preset number of times, setting the customer tab of the customer as a high-intent customer.

11. The computer equipment of claim 9, wherein the step of determining whether to provide manual service for the customer according to the customer tab of the customer comprises:
if the customer tab of the customer is a high-intent customer, it is determined to provide manual service for the customer.

12. The computer equipment of claim 9, wherein the step of updating the customer tab of the customer according to the result of the manual service comprises:
determining whether a transaction of the product is completed according to the result of the manual service;
if the transaction of the product is not completed, obtaining a labeling result for the customer from the manual service; and
updating the customer tab of the customer according to the labeling result for the customer from the manual service.

13. The computer equipment of claim 9, wherein the processor, when executing the computer readable instructions, further implements following steps:
acquiring customer conversation data of multiple customer tabs, wherein the customer tabs comprise the high-intent customers, low-intent customers and neutral customers;
taking the customer conversation data of which the customer tabs are high-intent customers as a positive intention data set;
taking the customer conversation data of which the customer tabs are low-intent customers as a negative intention data set;
taking the customer conversation data of which the customer tabs are neutral customers as a neutral data set;
aggregating the customer conversation data of the positive intention data set, negative intention data set and neutral data set into inclination data, and identifying inclination of each utterance in the inclination data to obtain an inclination data set; and
performing classifier training according to the positive intention data set, negative intention data set, neutral data set and inclination data set to obtain the preset multi-factor intent classifier.

14. The computer equipment of claim 13, wherein the step of performing classifier training according to the positive intention data set, negative intention data set, neutral data set and inclination data set to obtain the preset multi-factor intent classifier comprises:
performing intention classification learning according to the positive intention data set, negative intention data set and neutral data set to obtain an intention classification learning result;
performing inclination classification learning according to the inclination data set to obtain an inclination classification learning result; and
adjusting the intention classification learning according to the inclination classification learning result and the intention classification learning result to obtain the preset multi-factor intent classifier.

15. One or more readable storage mediums storing computer readable instructions, wherein the computer readable instructions, when executed by one or more processors, cause the one or more processors to implement following steps:
acquiring a conversation content between a customer and a customer service robot;
inputting the conversation content into a preset multi-factor intent classifier to obtain a recognition result of product purchase intention output by the preset multi-factor intent classifier, wherein the preset multi-factor intent classifier is obtained by training product purchase intention classification and conversation utterance inclination classification according to customer conversation data of multiple customer tabs, and the customer tabs include high-intent customers who have product purchase intention, low-intent customers who refuse the product and neutral customers who do not express their attitudes on the product;
setting a customer tab for the customer according to the recognition result of product purchase intention, and determining whether to provide manual service for the customer according to the customer tab of the customer;
acquiring a result of the manual service and conversation data of the customer in the manual service if the manual service is provided for the customer; and
updating the customer tab of the customer according to the result of the manual service, and updating the preset multi-factor intent classifier according to the conversation data of the customer.

16. The readable storage medium of claim 15, wherein the step of setting a customer tab for the customer according to the recognition result of product purchase intention comprises:
determining whether the recognition result of product purchase intention is high purchase intention;
if the recognition result of product purchase intention is determined to be high purchase intention, determining whether the number of times that the preset multi-factor intent classifier outputs the high purchase intention is greater than a preset number of times in conversation process; and
if the preset multi-factor intent classifier outputs the high purchase intention more than the preset number of times, setting the customer tab of the customer as a high-intent customer.

17. The readable storage medium of claim 15, wherein the step of determining whether to provide manual service for the customer according to the customer tab of the customer comprises:
if the customer tab of the customer is a high-intent customer, it is determined to provide manual service for the customer.

18. The readable storage medium of claim 15, wherein the step of updating the customer tab of the customer according to the result of the manual service comprises:
determining whether a transaction of the product is completed according to the result of the manual service;
if the transaction of the product is not completed, obtaining a labeling result for the customer from the manual service; and
updating the customer tab of the customer according to the labeling result for the customer from the manual service.

19. The readable storage medium of claim 15, wherein the computer readable instructions, when executed by one or more processors, cause the one or more processors to further implement following steps:
acquiring customer conversation data of multiple customer tabs, wherein the customer tabs comprise the high-intent customers, low-intent customers and neutral customers;
taking the customer conversation data of which the customer tabs are high-intent customers as a positive intention data set;
taking the customer conversation data of which the customer tabs are low-intent customers as a negative intention data set;
taking the customer conversation data of which the customer tabs are neutral customers as a neutral data set;
aggregating the customer conversation data of the positive intention data set, negative intention data set and neutral data set into inclination data, and identifying inclination of each utterance in the inclination data to obtain an inclination data set; and
performing classifier training according to the positive intention data set, negative intention data set, neutral data set and inclination data set to obtain the preset multi-factor intent classifier.

20. The readable storage medium of claim 19, wherein the step of performing classifier training according to the positive intention data set, negative intention data set, neutral data set and inclination data set to obtain the preset multi-factor intent classifier comprises:
performing intention classification learning according to the positive intention data set, negative intention data set and neutral data set to obtain an intention classification learning result;
performing inclination classification learning according to the inclination data set to obtain an inclination classification learning result; and
adjusting the intention classification learning according to the inclination classification learning result and the intention classification learning result to obtain the preset multi-factor intent classifier.
